(19) United States
(12) Patent Application Publication
(10) Pub. No.: US 2009/0062449 A1
(43) Pub. Date: Mar. 5, 2009

(54) THERMALLY CONDUCTIVE UNDERFILL FORMULATIONS

(76) Inventor: DONGYI WANG, Cary, NC (US)

Correspondence Address: LORD CORPORATION;PATENT & LEGAL SERVICES, 111 LORD DRIVE, P.O. Box 8012, CARY, NC, 27512-8012, US

(21) Appl. No.: 12/175,757

(22) Filed: Jul. 18, 2008

Related U.S. Application Data
(60) Provisional application No. 60/950,443, filed on Jul. 18, 2007.

(51) Int. Cl. C08K 3/22; C08G 65/02

(52) U.S. Cl. 524/430; 524/612

(57) ABSTRACT

A thermally conductive composition particularly well suited for use as an underfill composition including a curable resin and filler particles having an average diameter of less than 25 microns, wherein the filler particles are present in an amount sufficient to provide a thermal conductivity of greater than 0.5 W/mK and a viscosity of less than 0.600 Pa·s at 90° C. as measured with a 20 mm parallel plate at shear rate of 30 1/s.

### CROSS REFERENCE TO RELATED APPLICATIONS

The present application claims priority under 35 U.S.C. §119(e) from U.S. Provisional Patent Application Ser. No. 60/950,443 filed Jul. 18, 2008, entitled “THERMALLY CONDUCTIVE UNDERFILL FORMULATIONS”, the disclosure of which is incorporated herein by reference.

### FIELD OF THE INVENTION

The present invention relates to packaging for integrated circuits and related components. More particularly, the present invention relates to thermally conductive underfill compositions which are particularly well suited for flip-chip and other designs that require heat dissipation through the underfill layer.

### BACKGROUND OF THE INVENTION

Flip Chip and Wafer Level Packaging are two of the fastest growing segments in the integrated circuit packaging industry due to their design advantages. Both of them impose significant new demands on underfill encapsulation materials, specifically the underfilling process requirements, underfill properties and reliability of packaged devices. In the meantime, switching to lead free solders and the concern over anhydrides used in traditional underfills further challenge material suppliers to develop alternative non-anhydride type chemistries for the lead-free component packaging. Anhydrides have already been banned in Europe and regulations in other jurisdictions are growing stricter.

Prior art attempts have included thermally but not electrically conductive fillers such as various grades of zinc oxide, boron nitride, aluminum nitride, and large size aluminum oxide, but none has provided a good combination of particle size, non-settling filler, thermal conductivity and flow property (viscosity), all necessary for a successful underfill. All these thermally conductive fillers are commonly used in industry to make other types of thermal conductive products, such as potting compounds or thermally conductive greases and adhesives. However, these products do not have the features that are required by thermally conductive underfill applications, such as filler size, size distribution, shape, morphology, non-abrasive, anti-settling properties, surface characteristics, and interaction with the resin system that is in the formulation.

It is to these perceived needs that the present invention is directed.

### SUMMARY OF THE INVENTION

Embodiments of the present invention solve key challenges in developing underfill technologies imposed by the package geometries (smaller gaps and denser area array interconnects) and performance requirements (faster flow, better reliability performance and thermal conductivity). These new demands on underfill properties will require polymeric materials with improved chemistries and fillers with specially selected size distribution and morphology. In particular, the compositions of the present invention relate to underfills with low viscosity, small particle size filler, fast flow and high reliability. In a preferred embodiment of the present invention, the compositions are substantially anhydride-free. These properties are essential in the underfill design process for encapsulation of small to large die with low stand-off heights, i.e. less than 25 microns, between the die and the substrate.

One advantage of an embodiment of the present invention includes small, possibly less than 1 micron size, spherical alumina in underfill formulas that provide desired thermal conductivity and low viscosity for fast flow into small gap flip chip devices.

A further advantage of an embodiment of the present invention provides a filled curable material in which the filler resists settling while the material is being applied and prior to achieving a full cure. The materials of the present invention unexpectedly resist settling of the filler and allow for extended open times and workability of the final formulation. Further, the anti-settling properties of the sub 25 micron filler particles keep any larger filler particles from settling in the final formulation.

Another advantage of an embodiment of the present invention provides the processing necessary to achieve small particle size in product and ensures low viscosity, consistency, and capability of flow into a small gap.

An additional advantage in an embodiment of the present invention provides a smooth filler particle which reduces or eliminates abrasion of the dispensing equipment.

The formulations of the various embodiments of the present invention provide several advantages over the prior art including: filler size, size distribution, shape, morphology, surface characteristics, and interaction with the curable resin system that is in the formulation. In a preferred embodiment of the present invention, the key properties desired are higher thermal conductivity and low viscosity at application temperature (90° C.) on the customer production line, and also the small size filler particles permits the flow into the small gap between the flip chip and the substrate, with the size of the gap being less than 25 microns.

In a first aspect of the present invention, a thermally conductive composition is provided comprising a curable resin and filler particles having an average diameter of less than 25 microns, and the filler particles are present in an amount sufficient to provide a thermal conductivity of greater than 0.5 W/mK and a viscosity of less than 0.600 Pa·s at 90° C. as measured with a 20 mm parallel plate at shear rate of 30 1/s.

In one embodiment of the present invention, the filler particles preferably comprise alumina, and more preferably comprise substantially spherical alumina particles, and even more preferably filler comprises particles having a smooth surface.

In a further embodiment of the present invention, the average filler particle size is less than 5 microns, and more preferably the average filler particle size is less than or equal to 1 micron. In another embodiment of the present invention, the filler comprises a particle size having a D₅₀ from 0.2 to 1.5 microns and a D₁₀₀ from 5 to 15 microns.

In an additional embodiment of the present invention, the curable resin comprises an epoxy resin, and more preferably the curable composition is essentially free of anhydride compounds. In a further embodiment of the present invention, the composition further comprises an imidazole catalyst and optionally a surfactant.

In one preferred embodiment of the present invention, the filler is present in an amount from 30 to 85 percent by weight based on the total weight of the composition. In another preferred embodiment of the present invention, the filler is present in an amount greater than 50 weight percent based on the total weight of the composition. In an additional embodiment of the present invention, the filler is present at about 56 percent by weight based on the total weight of the composition.

In another aspect of the present invention, the composition comprises two sets of filler particles, a first set of filler particles having an average particle diameter of about 1 to about 20 microns, and a second set of filler particles having an average particle diameter of less than 1 micron. In one aspect of the present invention, the second set of filler particles has an average particle diameter of less than about 500 nanometers. In a further aspect of the present invention, the second set of filler particles has an average particle diameter of less than about 150 nanometers, and more preferably the second set of filler particles has an average particle diameter of about 100 nanometers.

In one embodiment of the present invention, the filler particles have a settling time that is greater than the cure time. In another embodiment of the present invention, the settling time is defined as the time during which a homogenous mixture of filler in resin settles until the concentration of filler at the bottom of the composition varies by more than 10 percent from the concentration of filler at the top of the composition at a temperature of 90° C., and the cure time is defined as the amount of time it takes the viscosity to increase from about 0.600 Pa·s at 90° C. to greater than 100 Pa·s at 90° C.

In a further aspect of the present invention, a curable composition is provided comprising a curable resin and a filler wherein the filler comprises thermally conductive, smooth, spherical particles having an average diameter of less than about 5 microns, wherein said filler will not settle in the uncured resin for at least 2 days at a temperature of greater than 50° C.

In yet another aspect of the present invention, a method of manufacturing a curable composition comprising the steps of; providing a curable resin, providing a filler having an average particles size of 1-5 microns, wherein the particles are present in agglomerations comprising a plurality of the smaller particles, mixing the filler and curable resin, providing a 3-roll mill, and milling the filler and resin mixture until a majority of the agglomerations are broken into individual particles and said particles are dispersed throughout the filler.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION

In one aspect of the present invention, an underfill formulation is provided comprising a curable resin and a filler having a particle size of less than 25 microns. This formulation has the unique properties of increased thermal conductivity as compared to prior art fillers along with a low viscosity of the product for practical use on customer's production line. The low viscosity allows for fast flow into a small gap flip chip device.

The present invention is particularly well suited for use as an underfill used to fill the gap between chip and substrate in a flip chip integrated circuit design. The formulations employed a special alumina particulate filler. The specific characteristics of the filler made the formulated products with special and desired properties. These properties could not be obtained by previously known conventional formulation approaches.

In an embodiment of the present invention the curable resin comprises an epoxy resin such as monofunctional and multifunctional glycidyl ethers of Bisphenol-A and Bisphenol-F, aliphatic and aromatic epoxies, saturated and unsaturated epoxies, cycloaliphatic epoxy resins and combinations of those. Another suitable epoxy resin is epoxy novolac resin, which is prepared by the reaction of phenolic resin and epichlorohydrin. A preferred epoxy novolac resin is poly(phenyl glycidyl ether)-co-formaldehyde. Other suitable epoxy resins are biphenyl epoxy resin, commonly prepared by the reaction of biphenyl resin and epichlorohydrin; dicyclopentadiene-phenol epoxy resin; naphthalene resins; epoxy functional butadiene acrylonitrile copolymers; epoxy functional polydimethyl siloxane; and mixtures of the above. Non-glycidyl ether epoxides may also be used. Suitable examples include 3,4-epoxycyclohexylmethyl-3,4-epoxycyclohexane carboxylate, which contains two epoxide groups that are part of the ring structures and an ester linkage; vinylcyclohexene dioxide, which contains two epoxide groups and one of which is part of the ring structure; 3,4-epoxy-6-methyl cyclohexyl methyl-3,4-epoxycyclohexane carboxylate; and dicyclopentadiene dioxide. In a further embodiment of the present invention, the curable resin comprises any curable material comprising the adhesion, modulus, and rheology desired for a particular application. Examples of such materials include silicones, polyesters, and urethanes. In a further embodiment of the present invention, the composition optionally comprises surfactants, colorants, catalysts, coupling agents and the like.

In an embodiment of the present invention wherein the composition is employed as a thermally conductive underfill composition, the filler preferably comprises a thermally conductive and substantially electrically insulating material. In one preferred embodiment of the present invention, the filler comprises spherical alumina particles. In other embodiments of the present invention, suitable non-conductive fillers include silica, mica, talc, hollow glass beads, zinc oxide, magnesium oxide and mixtures thereof.

In another preferred embodiment of the present invention, the filler comprises an average particle size of less than 25 microns. In a further embodiment of the present invention, the filler comprises a particle size of less than 5 microns. In a most preferred embodiment of the present invention the filler comprises a particle size of less than or equal to about 1 micron. In a still further embodiment of the present invention, the filler comprises a particle size having D₅₀=0.2 to 1.5 and D₁₀₀=5 to 15 microns.

In one embodiment of the present invention, the filler is present in an amount from about 30 to about 85 weight percent based on the total weight of the material. In another embodiment of the present invention, the filler is present in an amount greater than 50 weight percent based on the total weight of the material. In a preferred embodiment of the present invention the filler is present in an amount of about 56 weight percent based on the total weight of the material. Lower filler concentrations decreases thermal conductivity, but also decreases viscosity. Higher filler concentrations increase thermal conductivity, but also increase viscosity. Therefore a balance must be found between optimum levels of thermal conductivity and viscosity for any particular application. Additionally, many applications which undergo thermal cycling require matching coefficients of thermal expansion (CTE) between the underfill and the chip/substrate. Appropriate filler selection and loading is necessary to control CTE.

In a further embodiment of the present invention, the filler comprises any suitable material for flip chip application including those which are thermally conductive, but not electrically conductive. In another embodiment of the present invention the filler preferably comprises a spherical shape with a smooth surface. Fillers comprising a smooth spherical shape allow for optimum control of viscosity and non-abrasiveness in the final formula. This allows for a final formulation which has an appropriate viscosity to allow for dispensing (either in a wafer applied underfill or b-stageable underfill) and minimal abrasion of the dispensing equipment.

In a further embodiment of the present invention, the filler provides beneficial anti-settling properties. More spherical particles provide better anti-settling properties. Additionally, as particle size decreases, anti-settling improves. Therefore, the preferred particles are small, i.e. about 1 micron or less in average particle size, and spherical or nearly spherical.

In one embodiment of the present invention, the anti-settling properties are evident in a composition in which the filler particles have a settling time which is greater than the cure time. For the purposes herein, settling time is defined as the time during which a homogenous mixture of filler in resin settles until the concentration of filler at the bottom of the composition varies by more than 10 percent from the concentration of filler at the top of the composition at a temperature of 90° C., and the cure time is defined as the amount of time it takes the viscosity to increase from about 0.600 Pa·s at 90° C. to greater than 100 Pa·s at 90° C. Such anti-settling parameters ensure a composition can be shipped, disposed on a substrate, and cured before the filler settles in an unacceptable manner.

In a further embodiment of the present invention, a first set of larger filler particles are kept in suspension with the addition of a second set of smaller filler particles. These two sets of filler particles may comprise the same filler material, or differing filler materials. In this embodiment the larger filler particles comprise an average particle diameter of greater than 1 micron. In a further embodiment of the present invention, the larger filler particles comprise an average particle diameter of 1 to 20 microns. The smaller filler particles comprise an average particle diameter of less than 1 micron, preferably less than 500 nanometers, more preferably less than 150 nanometers, and most preferably less than 100 nanometers.

### Manufacturing and Processing

In another aspect of the present invention, a method for preparing the compositions of the present invention is provided. In one embodiment of the present invention, the method includes a first step of roll milling the resin-filler mixture to break down any agglomerations of particles into individual sub 25 micron particles. Often small particles, such as those in the 1 micron range will naturally agglomerate in bundles of 100 microns or more. Conventional process using high speed disperser is not able to break down the agglomerate due to their small particle size. Since these filler particle agglomerations are often quite strong, standard milling or dispersing methods can result in damage to the mixing machine. For example, typical industrial 3-roll mills cannot provide accurate gap control, and the steel rolls cannot handle the preferred alumina filler particles.

In a preferred embodiment of the present invention, a specialized 3-roll mill is employed, which enables accurate gap control and also can handle a harsh filler such as alumina. This milling process ensures any large agglomerations of particles are broken up into individual particles or small agglomerations of no more than 25 microns.

### EXAMPLES

| Formulation | A | B | C | D | E |
|---|---|---|---|---|---|
| Mixture of MHHPA and HHPA* | 16.73 | 16.837 | 16.837 | — | — |
| Blend of epoxy resins** | 16.97 | 17.076 | 17.076 | 35.66 | 41.517 |
| Alumina filler (spheres | 65.22 | — | — | — | — |
| average 5 microns) | | | | | |
| Alumina Filler (1 micron) | — | 65.00 | 59.00 | 62.00 | 56.00 |
| Silane coupling agent | 0.21 | 0.21 | 0.21 | 0.21 | 0.40 |
| Imidazole based curing catalyst | 0.17 | 0.17 | 0.17 | 1.425 | 1.660 |
| Surfactant | 0.025 | 0.026 | 0.026 | 0.025 | 0.025 |
| Boron nitride | — | — | 6.00 | — | — |
| Colorant | 0.68 | 0.68 | 0.68 | 0.68 | 0.40 |
| Total | 100 | 100 | 100 | 100 | 100 |
| Properties | | | | | |
| Viscosity (cps) | 1800 | 8,000 | 33,240 | 45,000 | 20,000 |
| Thermal K (W/mK) | 1.1 | 0.87 | 1.0 | 1.1 | 0.80 |
| Tg | 126° C. | 101° C. | 135° C. | 135° C. | 135° C. |
| Filler settling | Badly | No | No | no | no |

*MHHPA = methyl hexahydrophthalic anhydride, HHPA = hexahydrophthalic anhydride
**a mixture comprising 1) epoxy of Bisphenol-F type, 2) 2,2,6,6-tetramethyl biphenyl diglycidyl ether, and 3) triglycidyl ether of 4-aminophenol.

Formulation A comprises an anhydride-based formulation comprising an alumina filler with an average particle size of 5 microns. This formulation demonstrated the 5 micron alumina filler is able to achieve low viscosity and bulk thermal conductivity (BTC) above 1 W/mK. Comparatively, typical underfills employing silica filler will only give BTC 0.2-0.4 W/mK. However, the rapid settling of the alumina filler during the underfill curing, and the larger size filler may be unsuitable for some small gap flip chip devices, but will have utility in other applications.

To accommodate the smaller dimensions of some flip chip devices, Formulations B and C were prepared comprising 1.0 micron (average) alumina filler in the anhydride system. Both Formulations B and C provide good thermal conductivity (above 0.5 and preferably 1.0 W/mK) and settling properties. However, some applications require an anhydride-free system.

Formulation D provides an anhydride free system with excellent thermal conductivity, however it may be approaching the upper limits of viscosity for certain applications such as those requiring good flow under a die.

Formulation E provides better flow properties with lower viscosity, to accommodate certain end uses. Though, it is noted that the thermal conductivity is reduced somewhat to accommodate these changes. This formulation combines the benefits of high thermal conductivity with low viscosity.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

What is claimed is:

1. A thermally conductive composition comprising a curable resin and filler particles having an average diameter of less than 25 microns, wherein the filler particles are present in an amount sufficient to provide a thermal conductivity of greater than 0.5 W/mK and a viscosity of less than 0.600 Pa·s at 90° C. as measured with a 20 mm parallel plate at shear rate of 30 1/s.

2. The composition of claim 1, wherein the filler particles comprise alumina.

3. The composition of claim 1, wherein the alumina comprises substantially spherical particles.

4. The composition of claim 1, wherein the filler comprises particles having a smooth surface.

5. The composition of claim 1, wherein the average filler particle size is less than 5 microns.

6. The composition of claim 1, wherein the average filler particle size is less than or equal to 1 micron.

7. The composition of claim 1, wherein the filler comprises a particle size having a D₅₀ from 0.2 to 1.5 microns and a D₁₀₀ from 5 to 15 microns.

8. The composition of claim 1, wherein the curable resin comprises an epoxy resin.

9. The composition of claim 1, wherein the curable composition is essentially free of anhydride compounds.

10. The composition of claim 1, further comprising an imidazole catalyst.

11. The composition of claim 1, further comprising a surfactant.

12. The composition of claim 1, wherein the filler is present in an amount from 30 to 85 percent by weight based on the total weight of the composition.

13. The composition of claim 1, wherein the filler is present in an amount greater than 50 weight percent based on the total weight of the composition.

14. The composition of claim 1, wherein the filler is present at about 56 percent by weight based on the total weight of the composition.

15. The composition of claim 1, comprising two sets of filler particles, a first set of filler particles having an average particle diameter of about 1 to about 20 microns, and a second set of filler particles having an average particle diameter of less than 1 micron.

16. The filler of claim 15, wherein the second set of filler particles has an average particle diameter of less than about 500 nanometers.

17. The filler of claim 16, wherein the second set of filler particles has an average particle diameter of less than about 150 nanometers.

18. The filler of claim 16, wherein the second set of filler particles has an average particle diameter of about 100 nanometers.

19. The composition of claim 1, wherein the filter particles have a settling time that is greater than the cure time.

20. The composition of claim 19, wherein settling time is defined as the time during which a homogenous mixture of filler in resin settles until the concentration of filler at the bottom of the composition varies by more than 10 percent from the concentration of filler at the top of the composition at a temperature of 90° C., and the cure time is defined as the amount of time it takes the viscosity to increase from about 0.600 Pa·s at 90° C. to greater than 100 Pa·s at 90° C.

21. The composition of claim 1, wherein the composition is employed as a thermally conductive underfill.

22. A curable composition comprising a curable resin and a filler wherein the filler comprises thermally conductive, smooth, spherical particles having an average diameter of less than about 5 microns, wherein said filler will not settle in the uncured resin for at least 2 days at a temperature of greater than 50° C.

23. A method of manufacturing a curable composition comprising the steps of:
providing a curable resin;
providing a filler having an average particles size of 1-5 microns, wherein the particles are present in agglomerations comprising a plurality of the smaller particles;
mixing the filler and curable resin;
providing a 3-roll mill; and,
milling the filler and resin mixture until a majority of the agglomerations are broken into individual particles and said particles are dispersed throughout the filler.
